(19) United States
(12) Patent Application Publication
(10) Pub. No.: US 2011/0172437 A1
(43) Pub. Date: Jul. 14, 2011

(54) Perfluorophthalocyanine Molecules and Methods of Synthesis

(75) Inventors: Sergiu M. Gorun, Montclair, NJ (US); Robert Gerdes, Ulm (DE); Olga Gerdes, Ulm (DE); Lukasz Lapok, Slaskie (PL)

(73) Assignee: NEW JERSEY INSTITUTE OF TECHNOLOGY, Newark, NJ (US)

(21) Appl. No.: 12/935,670

(22) PCT Filed: Apr. 1, 2009
(86) PCT No.: PCT/US09/39172

§ 371 Date: Mar. 28, 2011

Related U.S. Application Data
(60) Provisional application No. 61/072,571, filed on Apr. 1, 2008.
(60) Provisional application No. 61/118,830, filed on Dec. 1, 2008.

(51) Int. Cl. C07F 15/00; C07F 1/08

(52) U.S. Cl. 548/402

(57) ABSTRACT

Advantageous methods for synthesis of fluorinated phthalocyanines are provided. Typical implementation involves a reaction mixture that includes perfluoro compound that is reacted for a reaction period sufficient to yield a fluorinated phthalocyanine of formula F₆₄PcM, wherein “Pc” is any phthalocyanine macrocycle and “M” is hydrogen. Novel fluorinated phthalocyanine molecules/compounds are also provided herein, including specifically compounds that include fluorinated phthalocyanines wherein “M” is Cu or V═O. The fluorinated phthalocyanines have wide ranging applications, e.g., corrosion-related applications, coating-related applications, catalysis, and the production of optical and electronic materials.

### CROSS-REFERENCE TO RELATED APPLICATION

The present application claims the benefit of two (2) co-pending, provisional patent applications. A first provisional patent application was filed on Apr. 1, 2008, and assigned Ser. No. 61/072,571. The second provisional patent application was filed on Dec. 1, 2008, and assigned Ser. No. 61/118,830. The entire content of each of the foregoing provisional patent applications is incorporated herein by reference.

### STATEMENT OF RIGHTS TO INVENTIONS MADE UNDER FEDERALLY SPONSORED RESEARCH

This work was supported by the government, in part, by a grant from the U.S. Army (Award No. DAAE30-03-D-1015-0019UA). The U.S. government may have certain rights to this invention.

### BACKGROUND

1. Technical Field

The present disclosure is directed to advantageous methods for synthesizing fluorinated phthalocyanines by microwave-assisted methods and to novel phthalocyanine molecules. The novel phthalocyanines molecules disclosed herein may be synthesized using the disclosed microwave-assisted methods or by alternative synthesis techniques and modalities.

2. Background Art

Phthalocyanines (Pc) have long proven to be of high interest in both basic research and practical applications due to their electrical and optical properties [P. Gregory, J. Porphyrins Phthalocyanines 4, 432 (2000)]. Macrocyclic complexes (metal and non-metal), such as PcM, are of considerable value because of the numerous possibilities of chemical modifications of both the central metal and organic ligand [N. B. McKeown in: K. M. Kadish, K. M. Smith, and R. Guilard (eds.) The Porphyrin Handbook (vol. 15) (Academic Press, San Diego 2003) p. 61-124], viz., the ring substituents. As used herein and unless otherwise noted:
M=a metal, a non-metal or hydrogen
Pc=any phthalocyanine macrocycle
   The electrical properties of the noted macrocyclic complexes are of particular interest, provided crystals and films can be obtained. Even though the charge carrier mobility in PcM films is typically lower than in many other molecular semiconductors, crystals of phthalocyanines that showed a field-effect mobility of up to 1 cm²V⁻¹s⁻¹ have been grown [Y. Shirota and H. Kageyama, Chem. Rev. 107, 953 (2007)].

Chemical modification of phthalocyanines leads to systematic changes in both their redox potential and molecular configuration, opening the possibility of detailed tuning of the structure and energy levels in the solid state. One approach to modifying phthalocyanines is aimed at the metal or non-metal core, the nature of which can be varied and to which a variety of axial ligands can be attached. Axial ligands range from single atoms, such as halogen and oxygen, present for example in PcV═O, PcTi═O, PcInCl and PcAlF, to organic groups such as methyl, ethyl, pyridine, or fluorophenyl [A. Auger, P. M. Burnham, I. Chambrier, M. J. Cook, and D. L. Hughes, J. Mater. Chem., 15, 168 (2005)]. A second path to new Pc complexes is to vary the ring substituents. For example, F-atoms can be introduced to modify the periphery of the Pc ligand, leading to partly fluorinated (F₄Pc, F₈Pc, F_{14.5}Pc) [H. Brinkmann, C. Kelting, S. Makarov, O. Tsaryova, G. Schnurpfeil, D. Wöhrle, and D. Schlettwein, Phys. Stat. Sol. (a) 205, 409 (2008); S. Isoda, S. Hashimoto, T. Ogawa, H. Kurata, S. Moriguchi, and T. Kobayashi, Mol. Cryst. Liq. Cryst. 247, 191 (1994); S. Hashimoto, S. Isoda, H. Kurata, G. Lieser, and T. Kobayashi, J. Porphyrins Phthalocyanines 3, 585 (1999)] or perfluorinated phthalocyanines (F₁₆Pc) [D. Schlettwein, H. Tada, and S. Mashiko, Langmuir 16, 2872 (2000)]. Both the metal and non-metal centers (and their axial ligands), as well as the ring substituents, induce a variety of solid-state architectures, as revealed, for example, by single-crystal X-ray structure determinations.

The presence of electron-withdrawing ring substituents, in particular such as halogens, lowers the energy of the molecular orbitals (MOs), including the frontier orbitals over a wide range. This effect was indicated for a number of phthalocyanines, including those bearing F-groups, by quantum chemical calculations of isolated molecules [N. Kobayashi and H. Konami in: C. C. Leznoff and A. B. P. Lever (eds.) Phthalocyanines Properties and Applications (vol. 4) (VCH Wiley, New York 1996); A. Ghosh, P. G. Gassman, and J Almlöf, J. Am. Chem. Soc. 116, 1932 (1994); M.-S. Liao, T. Kar, S. M. Gorun, and S. Scheiner Inorg. Chem. 43, 7151 (2004); S. P. Keizer, W. J. Han, J. Mack, B. A. Bench, S. M. Gorun, and M. J. Stillman J. Am. Chem. Soc. 125, 7067 (2003); M.-S. Liao, J. D. Watts, M-Ju Huang, S. M. Gorun, T. Kar, and S. Scheiner J. Chem. Theory Comput. 1, 1201 (2005)] by the observed shifts of the electrochemical potential of molecules in solution [M. L'Her and A. Pondaven in: K. M. Kadish, K. M. Smith, and R. Guilard (eds.) The Porphyrin Handbook (vol. 16) (Academic Press, San Diego 2003) p. 117-169] and by shifts of the ionization energy obtained by photoelectron spectroscopy for molecules in the gas phase [D. Schlettwein, K. Hesse, N. E. Gruhn, P. Lee, K. W. Nebesny, and N. R. Armstrong, J. Phys. Chem. B, 105, 4791 (2001)]. Even though additional solid-state effects are superimposed on molecular changes, the trends observed for individual molecules are clearly preserved in thin films, as exemplified by the ease of reduction and, hence, observed n-type conduction for fluorinated phthalocyanines.

According to Hu et al. (US Patent Publication No. 2003/0010621), synthesis of phthalocyanine by microwave irradiation was first proposed by Ahmad Shaabani in 1998. Mr. Shaabani reportedly proposed using phthalic anhydride having no side groups as the starting material. Microwave irradiation involves delivery of electromagnetic waves whereas conventional heating generally involves heat delivery by conduction, e.g., through a container containing a solution. In 1999, Ungurenasu proposed a process for preparing phthalocyanine by microwave irradiation with phthalonitrile or diaminoisoindoline as the starting material. The Hu publication referenced above discloses an organic solvent-free technique for synthesizing phthalocyanine compounds using microwave irradiation.

In the literature, Kahveci et al. disclose microwave-assisted synthesis of phthalocyanines. (“Microwave-assisted and conventional synthesis of new phthalocyanines containing 4-(pfluorophenyl)-3-methyl-4,5-dihydro-1H-1,2,4-triazol-5-one moieties,” Kahveci, Bahittin; Oezil, Musa; Kantar, Cihan; Sasmaz, Selami; Isik, Samil; Koeysal, Yavuz, Turk. Journal of Organometallic Chemistry (2007), 692(22), 4835-4842). More particularly, the preparation of metal-free (H₂) and metal (Zn, Ni, Cu and Co) phthalocyanines containing 4-(p-fluorophenyl)-3-methyl-4,5-dihydro-1H-1,2,4-triazol-5-one moiety from 1-(3,4-dicyanophenyl)-4-(p-fluorophenyl)-3-methyl-4,5-dihydro-1H-1,2,4-triazol-5-one by both conventional and microwave-assisted methods are disclosed.

However, the prior art neither teaches nor discloses the use of micro-wave assisted synthesis to fluorinated phthalocyanine materials. It is noted that the foregoing Kahveci et al. publication references microwave-assisted synthesis wherein a fluorine atom is present. However, the fluorine is not directly linked to the phthalocyanine ring and the distinction is significant. Indeed, the potential application of microwave-assisted synthesis modalities to fluorinated materials is highly uncertain due to the peculiar redox properties induced by fluorinated phthalocyanine ring substituents.

Thus, despite efforts to date, a need remains for improved methods/techniques for phthalocyanine synthesis, particularly methods/techniques generating higher yields and/or simplifying/facilitating associated purification processes. A need also exists for methods/techniques for phthalocyanine synthesis that allow and/or address an ability to synthesize a broader range of starting materials and/or broaden the range of feasible synthesized molecules. Still further, a need exists for further phthalocyanine molecules/compounds to address various industrial/commercial applications.

These and other needs are satisfied by the advantageous methods/techniques and molecules/compounds disclosed herein, as well as applications of such molecules/compounds.

### SUMMARY

The present disclosure is directed to advantageous methods for synthesis of phthalocyanine molecules/compounds, including specifically fluorinated phthalocyanines. The disclosed microwave-assisted methods for synthesis advantageously enhance the yield relative to conventional synthesis techniques. In addition, the microwave-assisted methods disclosed herein are rapid (e.g., minutes as compared to hours), eliminate or substantially eliminate reaction solvents, and facilitate purification through reduced impurities. Still further, the disclosed microwave-assisted methods have been found to broaden the range of starting materials that may be effectively employed in phthalocyanine molecules, as well as broadening the range of feasible synthesized phthalocyanine molecules.

The present disclosure is also directed to novel fluorinated phthalocyanine molecules/compounds. In particular, novel fluorinated phthalocyanine molecules of the general formula PcMF₆₄, wherein Pc is any phthalocyanine, M is Cu or V(O) and F is fluorine.

The disclosed fluorinated phthalocyanine molecules/compounds have wide ranging potential commercial and other applications, including specifically corrosion-related applications, coating-related applications, catalysis, and the production of optical and electronic materials. Further advantageous applications of the disclosed molecules/compounds will be readily apparent to persons skilled in the art.

Additional features, functions and applications of the disclosed compounds/molecules will be apparent from the detailed description which follows.

### DESCRIPTION OF EXEMPLARY EMBODIMENT(S)

1. Experimental:

To demonstrate the application of the disclosed microwave-assisted synthesis of fluorinated phthalocyanines and the synthesis of novel phthalocyanine molecules, several exemplary syntheses are described hereinbelow. However, it is to be understood that the present disclosure is not limited by or to the disclosed syntheses. Rather, the syntheses disclosed herein are merely illustrative of the present disclosure.

### a. Microwave-Assisted Synthesis of PcZn

Commercial reagents and organic solvents were used as received. A microwave Discover CEM reactor was used for synthesis. PcZn was prepared by mixing 0.50 mmol of phthalonitrile with 0.13 mmol zinc acetate dihydrate, adding two drops of dimethyl formamide (DMF), and heating the mixture to 200° C. in a sealed tube with microwave application for 10 minutes. The resulting PcZn was purified by soxhlet extraction with acetone, CH₂Cl₂ and CH₃CN, followed by re-crystallization from pyridine. The yield was 95% vs. a reported conventional (non-microwave) yield of 87%. [See Villemin, D.; Hammadi, M.; Hachemi, Bar, N., Molecules, 2001, 6, 831.] The reaction product, 10⁻¹ g scale, was successfully characterized by IR, ¹H and ¹⁹F NMR, UV-Vis and EI-MS.

### b. Microwave-Assisted Synthesis of F₁₆PcZn

F16PcZn was synthesized in the same manner described above with reference to PcZn. Thus, a microwave Discover CEM reactor was again used for synthesis. The F₁₆PcZn was prepared by mixing 0.50 mmol of perfluorophthalonitrile with 0.13 mmol zinc acetate dihydrate, adding two drops of dimethyl formamide (DMF), and heating the mixture to 200° C. in a sealed tube with microwave application for 10 minutes. The F₁₆PcZn was purified by the same procedure noted above and yields were 59±10% vs. 45% reported for a conventional, non-microwave assisted synthesis. [See, Boyle R. W., Rousseau J., Kudrevich S. V., Obochi M. O. K., Van Lier J. E., Brit. J. Cancer, 1996, 73, 49.] The reaction product, 10⁻¹ g scale, was successfully characterized by IR, ¹H and ¹⁹F NMR, UV-Vis and EI-MS.

### c. Microwave-Assisted Synthesis of (R^{f})₈F₈PcZn, (F₆₄PcZn)

(R_{f})₈F₈PcZn, (F₆₄PcZn) [R_{f}=perfluoroisopropyl] was synthesized in the same manner as described above with reference to PcZn and F₁₆PcZn, but using instead perfluoro-(4,5-di-isopropyl) phthalonitrile which was prepared according to the literature. [See, Gorun, S. M.; Bench, B. A.; Carpenter, G.; Beggs, M. W.; Mague, J. T.; Ensley, H. E. J., Fluor. Chem., 1998, 91, 37.] In the case of (R_{f})₈F₈PcZn, (F₆₄PcZn), the reaction product was washed with toluene, purified by column chromatography on silica gel (acetone and hexane 3:7) and obtained in a yield of 91% vs. the reported 21% yield of a conventional, non-microwave assisted procedure. [See, Bench, B. A., Beveridge, A., Sharman, W. M., Diebold, G. J., van Lier, J. E., Gorun, S. M., Angew. Chem., Int. Ed., 2002, 41, 748.] The reaction product, 10⁻¹ g scale, was successfully characterized by IR, ¹H and ¹⁹F NMR, UV-Vis and EI-MS.

Of note, although the “R_{f}” ligand employed according to Example (c) was perfluoroisopropyl, alternative R_{f} ligands may be employed, e.g., alternative perfluoroalkyl ligands, without departing from the spirit or scope of the present disclosure.

### d. Microwave-Assisted Synthesis of 1,4,8,11,15,18,22,25-octa-fluoro-2,3,9,10,16,17,23,24-octa-perfluoroisopropyl copper(II) phthalocyanine

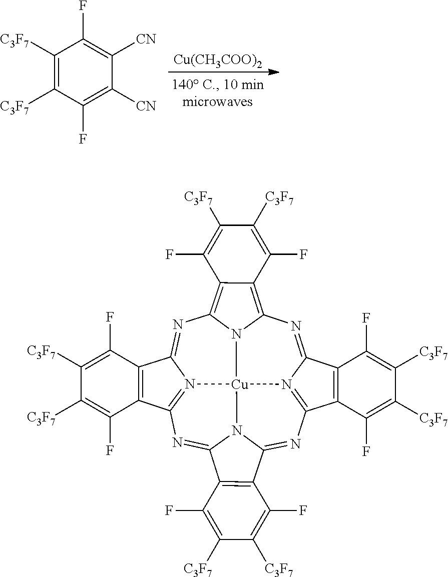

A mixture of perfluoro-(4,5-di-isopropyl)phthalonitrile (0.5 g, 1 mmol) and Cu(CH₃COOH)₂.H₂O (0.1 g, 0.5 mmol) was placed in a glass tube. The glass tube was sealed, inserted into the microwave reactor and heated to 140° C. for 10 min. 5 ml of toluene was added to the crude product. The resulting suspension was filtered and the precipitate was washed thoroughly with toluene, several milliliters of acetonitrile and again with toluene to remove unreacted phthalonitrile and brown impurities. The dark blue-green solid residue was dissolved in EtOAc and filtered. The crude product was purified using silica gel and a mixture of ethyl acetate/hexane (1:5). The blue fraction was collected. The blue compound was dissolved in a boiling ethanol and left to form crystalline material. Solid product was filtered and washed with acetone to remove green impurities. Yield 233 mg (45%). ¹F-NMR (250 MHz, d₆-acetone, C₆F₆ std): δ=−69.97 (CF₃, 48F), −107.28 (aromatic F, 8F), −164.20 (aliphatic F, 8F). UV-Vis (EtOH, 1×10⁻⁵ mol/l) λ nm (log ε): 681 (5.4), 613 (4.67), 383 (4.8). EI-MS (200° C., 70 eV): m/z 2063 [M⁺]. IR (KBr): ν=1597 w, 1507 s, 1454 s, 1286 vs, 1247 vs, 1219 vs, 1169 vs, 1187 vs, 1104 vs, 984 s, 967 s, 752 s, 730 s cm⁻¹.

### e. Control—Conventional Synthesis of 1,4,8,11,15,18,22,25-octa-fluoro-2,3,9,10,16,17,23,24-octa-perfluoroisopropyl copper(II) phthalocyanine

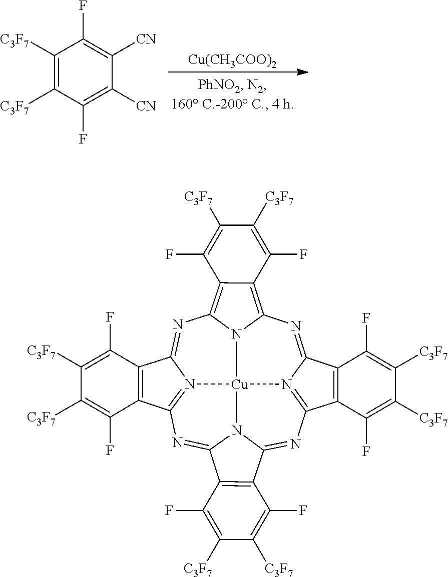

Perfluoro-(4,5-di-isopropyl)phthalonitrile (0.1 g, 0.2 mmol) and Cu(CH₃COOH)₂.H₂O (0.02 g, 0.1 mmol) were placed in a 25 ml two-necked flask equipped with a magnetic stirrer and a reflux condenser. 5 ml of freshly distilled nitrobenzene was transferred to the flask under nitrogen atmosphere. The reaction mixture was stirred initially at 160° C. and than at 200° C. for 4 h. Gradual formation of green product was observed. The solvent was removed under reduced pressure. The crude product was initially purified using silica gel and a mixture of ethyl acetate/petroleum ether (1:5). Greenish fraction was collected, solvent was removed and the product was purified again using silica gel and toluene to remove yellow impurities. The desired compound was than eluted as a blue band using mixture of ethyl acetate/petroleum ether (1:1). Yield 0.022 g (21%). ¹F-NMR (250 MHz, d₆-acetone, C₆F₆ std): δ=−69.97 (CF₃, 48F), −107.28 (aromatic F, 8F), −164.20 (aliphatic F, 8F). UV-Vis (EtOH, 1×10⁻⁵ mol/l) λ nm (log ε): 681 (5.4), 613 (4.67), 383 (4.8). EI-MS (200° C., 70 eV): m/z 2063 [M⁺]. IR (KBr): ν=1597 w, 1507 s, 1454 s, 1286 vs, 1247 vs, 1219 vs, 1169 vs, 1187 vs, 1104 vs, 984 s, 967 s, 752 s, 730 s cm⁻¹.

### f. Microwave-Assisted Synthesis of 1,4,8,11,15,18,22,25-octa-fluoro-2,3,9,10,16,17,23,24-octa-perfluoroisopropyl iron(II) phthalocyanine

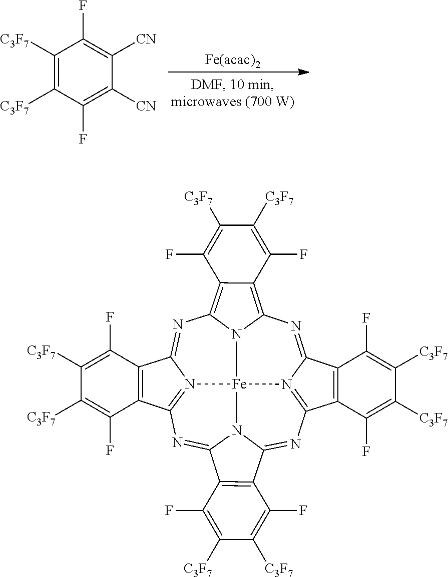

Perfluoro-(4,5-di-isopropyl)phthalonitrile (1.38 g, 2.76 mmol) and iron(II) acetylacetonate (0.350 g, 1.37 mmol) were ground in a mortar and transferred to a glass vessel. One drop of dimethyl-formamide (DMF) was added to the reaction mixture. The glass tube was sealed, than inserted into a microwave reactor and heated at 700 W for 10 min. The crude product was dissolved in an acetone/hexane (3:7) mixture and filtered using silica gel. Solvent was removed and the unreacted phthalonitrile was removed by sublimation (100° C., vacuum). The compound was crystallized from a mixture of acetone/hexane. Yield 0.83 g (69%). ¹F-NMR (250 MHz, d₆-acetone, C₆F₆ std): δ=−71.5 (CF₃, 48F), −105.9 (aromatic F, 8F), −164.8 (aliphatic F, 8F). EI-MS (200° C., 70 eV): m/z 2056 [M]⁺. UV-Vis (acetone) λ nm: 680. IR (KBr): ν=1717 w, 1594 w, 1510 w, 1457 m, 1429 w, 1286 vs, 1247 vs, 1219 vs, 1169 vs, 1155 vs, 1113 vs, 1096 vs, 981 s, 959 s, 867 w, 802 m, 783 m, 752 m, 730 s cm⁻¹.

### g. Microwave-Assisted Synthesis of 1,4,8,11,15,18,22,25-octa-fluoro-2,3,9,10,16,17,23,24-octa-perfluoroisopropyl vanadyl phthalocyanine

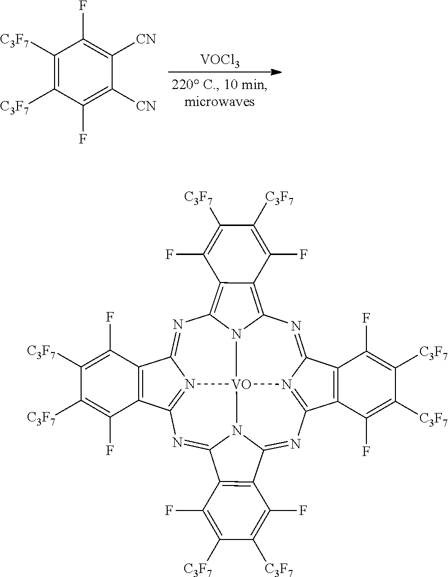

Perfluoro-(4,5-di-isopropyl)phthalonitrile (0.5 g, 1 mmol), VOCl₃ (0.4 ml) and 0.05 ml of dry DMF were transferred into the glass tube and sealed. The glass tube was inserted into a microwave reactor and the reaction mixture was heated at 225° C. for 10 min. The crude product was dissolved in ethyl acetate and the organic layer was washed several times with aqueous hydrochloric acid (pH=1) and than several times with distilled water. Ethyl acetate was evaporated and deep blue solid was obtained. The solid residue was purified by sublimation followed by column chromatography on silica gel with a 2:8 mixture of acetone and hexane to give a dark-blue solid in a 56% yield. ¹F-NMR (250 MHz, d₆-acetone, C₆F₆ std): δ=−69.64 (CF₃, 48F), −104.95 (aromatic F, 8F), −164.14 (aliphatic F, 8F). UV-Vis (EtOAc, 1×10⁻⁵ mol/l) λ nm (log ε): 693 (5.31), 625 (4.64), 387 (4.83). EI-MS (200° C., 70 eV): m/z 2067 [M]⁺. IR (KBr): ν=1457 m, 1331 m, 1283 vs, 1247 vs, 1219 vs, 1171 vs, 1149 s, 1101 vs, 1054 m, 984 s, 969 s, 861 m, 783 m, 754 s, 731 s cm⁻¹.

### h. Microwave-Assisted Synthesis of 1,4,8,11,15,18,22,25-octa-fluoro-2,3,9,10,16,17,23,24-octa-perfluoroisopropyl magnesium phthalocyanine

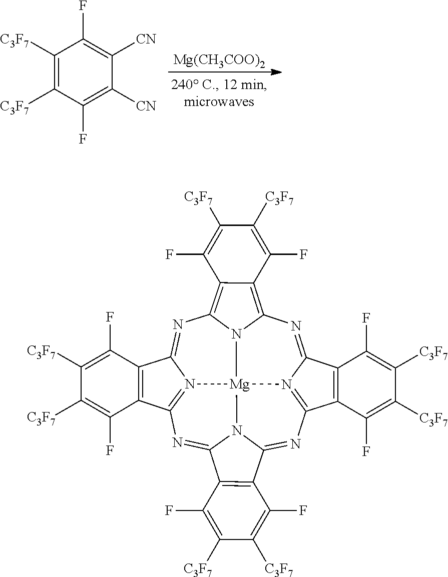

Perfluoro-(4,5-di-isopropyl)phthalonitrile (0.302 g, 0.6 mmol) and Mg(CH₃COOH)₂.4H₂O (0.040 g, 0.18 mmol) were transferred into the glass tube. The glass tube was sealed, than inserted into the microwave reactor and heated to 240° C. for 12 min. The crude product was purified by column chromatography using silica gel and a mixture of acetone/hexane 2:8 to remove part of the impurities. The blue fraction was collected using a mixture of acetone/hexane 4:6. The compound was purified additionally using a short column and a mixture of EtOAc/hexane 1:2 was passed through the column to remove yellow impurities and then a blue fraction was collected using a mixture of EtOAc/hexane 1:1. Yield 74 mg (24%). ¹F-NMR (250 MHz, d₆-acetone, C₆F₆ std): δ=−69.23 (CF₃, 48F), −106.97 (aromatic F, 8F), −164.35 (aliphatic F, 8F). UV-Vis (CHCl₃, 1×10⁻⁵ mol/l) λ nm (log ε): 693 (5.42), 663 sh, 625 (4.66), 388 (4.87). EI-MS (200° C., 70 eV): m/z 2024 [M⁺]. IR (KBr): ν=1749 w, 1650 w, 1454 w, 1278 s, 1249 vs, 1222 vs, 1170 s, 1149 s, 1097 s, 1057 m, 1018 m, 981 s, 968 s, 939 m, 858 w, 782 w, 753 m, 731 s, 472 m cm⁻¹.

### i. Microwave-Assisted Synthesis of Chloro-(1,4,8,11,15,18,22,25-octa-fluoro-2,3,9,10,16,17,23,24-octa-perfluoroisopropyl)phthalocyaninato indium(III)

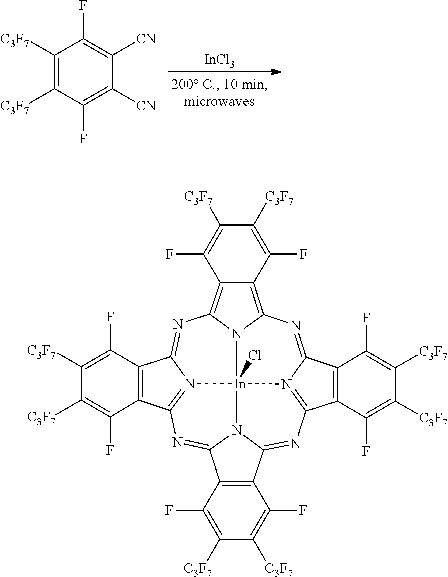

A mixture of InCl₃ (0.22 g, 1 mmol) and perfluoro-(4,5-di-isopropyl)phthalonitrile (0.5 g, 1 mmol) was placed in a glass tube. The glass tube was sealed, inserted into a microwave reactor and heated to 200° C. for 10 min. The crude product was washed with acetone and water (1:1), toluene, dissolved in Et₂O and filtered, giving 296 mg (yield=55%), dark green solid. IR (KBr): ν=1638 w, 1458 w, 1332 w, 1248 vs, 1171 s, 1103 s, 1056 w, 984 m, 968 s, 857 w, 784 w, 753 s, 731 s, 720 m cm⁻¹. ¹F-NMR (250 MHz, d₆-acetone, C₆F₆ std): δ=−70.05 (CF₃, 48F), −101.72 (aromatic F, 8F), −163.43 (aliphatic F, 8F). EI-MS (200° C., 70 eV): m/z 2150 [M⁺]. UV-Vis (acetone, 1×10⁻⁵ mol/l) nm (log ε): 697 (5.24), 627 (4.53), 413 (4.70).

### j. Microwave-Assisted Synthesis of Chloro-(1,4,8,11,15,18,22,25-octa-fluoro-2,3,9,10,16,17,23,24-octa-perfluoroisopropyl)phthalocyaninato gallium(III)

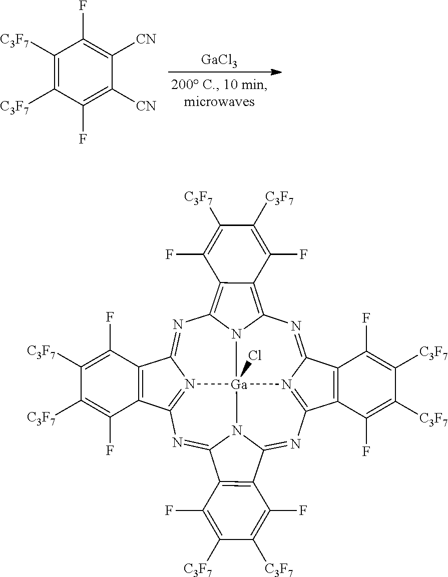

A mixture of GaCl₃ (0.088 g, 0.5 mmol) and perfluoro-(4,5-di-isopropyl)phthalonitrile (0.5 g, 1 mmol) was placed in a glass tube. The glass tube was sealed, inserted into a microwave reactor and heated to 200° C. for 10 min. The crude product was dissolved in EtOAc, washed with acetic acid, followed by distilled water until neutral pH. Short column chromatography using silica gel (70-230 Mesh, Fisher Scientific) and toluene followed by EtOH yielded 295 mg (56%), dark green solid. IR (KBr): ν=1748 w, 1615 w, 1457 w, 1431 w, 1339 m, 1286 s, 1250 vs, 1173 s, 1149 s, 1004 s, 1060 m, 1020 w, 971 s, 925 m, 788 w, 752 w, 733 m, 539 w, 460 m cm⁻¹. ¹F-NMR (250 MHz, d₆-acetone, C₆F₆ std): δ=−69.63 (CF₃, 48F), −107.21 (aromatic F, 8F), −164.59 (aliphatic F, 8F). EI-MS (200° C., 70 eV): m/z 2104 [M⁺]. UV-Vis (EtOAc, 1×10⁻⁵ mol/l) λ nm (log ε): 697 (4.93), 629 (4.38), 387 (4.54).

### k. Microwave-Assisted Synthesis of Carbonyl-(1,4,8,11,15,18,22,25-octa-fluoro-2,3,9,10,16,17,23,24-octa-perfluoroisopropyl)phthalocyaninato ruthenium(II)

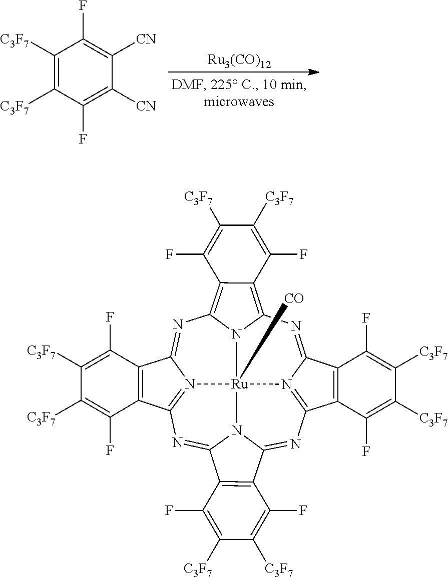

Perfluoro-(4,5-di-isopropyl)phthalonitrile (0.5 g, 1 mmol), Ru₃(CO)₁₂ (0.053 g, 0.083 mmol) and 0.05 ml of dry DMF were transferred into a glass tube and sealed. The glass tube was inserted into a microwave reactor and the reaction mixture was heated at 225° C. for 10 min. The crude product was washed with toluene chromatographed in silica gel using a 2:8 mixture of acetone and hexane. Yield 111 mg (21%), dark blue solid. IR (KBr): ν=2015, 1749, 1494, 1455, 1250, 1166, 969, 786, 731 cm⁻¹. ¹F-NMR (250 MHz, d₆-acetone, CFCl₃ std): δ=−71.4 (CF₃, 48F), −105.1 (aromatic F, 8F), −164.7 (aliphatic F, 8F) ppm. ¹³C NMR (100 MHz, d₆-acetone, CFCl₃ std) δ=154.3, 143.1, 132.2, 121.9, 117.9, 95.5 ppm. EI-MS (200° C., 70 eV): m/z 2102 [M-CO]⁺. UV-Vis (Acetone, 1×10⁻⁵ mol/l) λ nm (log ε): 656 (4.47), 352 (4.65).

### l. Synthesis of 29H,31H-1,4,8,11,15,18,22,25-octa-fluoro-2,3,9,10,16,17,23,24-octa-perfluoroisopropylphthalocyanine

i. Procedure 1.

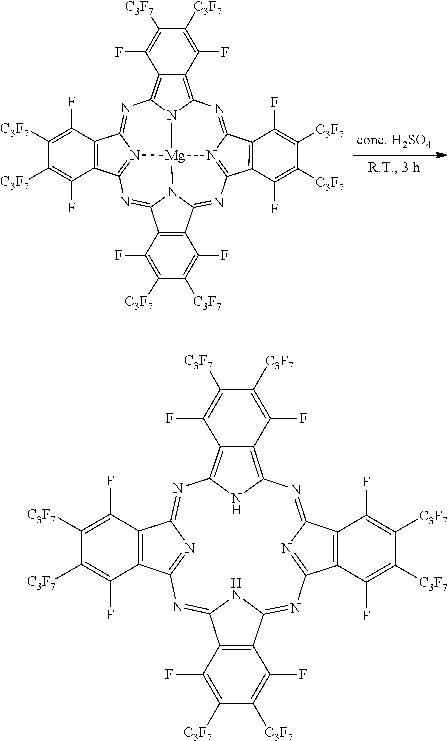

Magnesium phthalocyanine (400 mg) was dissolved in concentrated sulfuric acid (18 ml) and vigorously stirred for 3 hours at room temperature. The mixture was poured onto crushed ice and filtered. The precipitate was washed thoroughly with water and purified using silica gel and a mixture of acetone/hexane with a gradual increase of acetone concentration from 6:24 to 16:24. The dark-blue fraction was additionally purified on a short column filled with silica gel using initially a mixture of acetone/hexane 18:42, later changed to 28:42 to afford metal-free phthalocyanine as a dark-blue solid. Yield: 33%-46%. UV-Vis (chloroform): 715, 678, 656, 613 nm. ¹F-NMR (250 MHz, d₆-acetone, C₆F₆ std): δ=−70.98 (CF₃, 48F), −106.30 (aromatic F, 8F), −164.54 (aliphatic F, 8F). EI-MS (200° C., 70 eV): m/z 2002 [M⁺]. IR (KBr): λ=1638 m, 1479 w, 1450 w, 1286 s, 1247 vs, 1222 vs, 1169 s, 1149 s, 1091 s, 1054 w, 1015 w, 979 s, 966 s, 931 w, 753 m, 729 s, 716 s, 548 wcm⁻¹.

ii. Procedure 2.

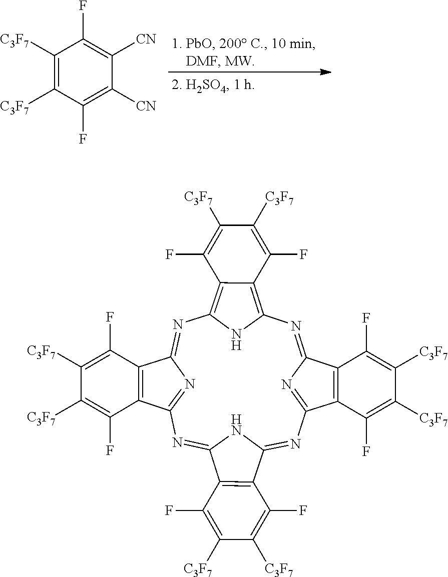

Perfluoro-(4,5-di-isopropyl)phthalonitrile (0.5 g, 1.0 mmol), PbO (0.06 g, 0.29 mmol) and 0.05 ml of DMF were transferred into a glass tube, sealed, and heated to 200° C. for 10 min in a microwave reactor. The crude product was suspended in concentrated H₂SO₄ and stirred vigorously for 1 hour at room temperature. The solution was poured onto crushed ice and the precipitate was collected by filtration, washed thoroughly with water, toluene, mixture of toluene and acetonitrile 1:1 and than with a small volume of pure acetonitrile (3-5 ml). The product was dissolved in ethyl acetate, filtered, and further purified by column chromatography on silica gel using a mixture of acetone and hexane 4:6. Yield: 150 mg (30%). The spectroscopic features of the product synthesized according to Procedure 2 were identical to those reported under Procedure 1. Of note, in Procedure 2 (unlike Procedure 1) a metal complex is not isolated as an intermediate.

As shown in Procedures 1 and 2, the disclosed acid-catalyzed methods are effective in directly synthesizing advantageous perfluorophthalocyanine molecules.

As is readily apparent, the microwave-assisted synthesis of fluorinated phthalocyanines is efficient and effective. Reaction times are relatively short, e.g., on the order of minutes as opposed to hour(s) for conventional syntheses, solvents are largely eliminated from the reaction mixtures, and purification is generally facilitated by reduced impurity levels. As demonstrated in the following table, microwave-assisted synthesis of fluorinated phthalocyanines generates advantageous yields, as shown most clearly by the comparative examples set forth therein.

TABLE
Comparison Between Microwave-Assisted
Synthesis and Published Synthesis Yields

| | Microwave-Assisted | Non-Microwave-Assisted |
|---|---|---|
| Compound | Synthesis Yield | Synthesis Yield |
| F₆₄ZnPc | 64% | 21%* |
| F₆₄CuPc | 45% | 16-20% |
| F₆₄V(O)Pc | 67% | Never tried. |
| F₆₄FePc | 78% | 50%** |
| F₆₄CoPc | 75%^{††} | 34%^{†} |
| ZnPc | 89% | 70-80% |

*Barbara A. Bench, Andrew Beveridge, Wesley M. Sharman, Gerald J. Diebold, Johan E. van Lier and Sergiu M. Gorun, Introduction of Bulky Perfluoroalkyl Groups at the Periphery of Zinc Perfluorophthalocyanine: Chemical, Structural, Electronic, and Preliminary Photophysical and Biological Effects, Angew. Chem. Int. Ed. 2002, 41, 748-750; Robert Gerdes, Lukasz Lapok, Olga Tsaryova, Dieter Wohrle and Sergiu M. Gorun, Rational Design of a Reactive Yet Stable Organic-Based Photocatalyst, Dalton Tran, 2009, 1098-1100.
**Hyun-Jin Lee, William W. Brennessel, Joshua A. Lessing, William W. Brucker, Victor G. Young, Jr. and Sergiu M. Gorun, Dome-distortion and fluorine-lined channels: synthesis, and molecular and crystal structure of a metal- and C—H bonds free fluorophthalocyanine, Chem. Comm. 2003, 1576-1577.
^{†}Barbara A. Bench, William W. Brennessel, Hyun-Jin Lee and Sergiu M. Gorun, Synthesis and Structure of a Boconcave Cobalt Perfluorophthalocyanine and Its Catalysis of Novel Oxidative Carbon-Phosphorus Bonds Formation by Using Air, Angew. Chem. Int. Ed. 2002, 41, 750-754.
^{††}Of note, microwave-assisted synthesis of F₆₄CoPc has been inconsistent and unpredictable to date. Indeed, the synthesis has been successful in certain instances and unsuccessful in other instances. The formation of Co metal -- raising issues for microwave application -- has also been observed on at least one occasion. Various factors may be contributing to the observed inconsistency, e.g., impurities in starting materials.

While the examples presented herein focus on metal cores, it is specifically noted that the disclosed microwave-assisted synthesis has equal applicability to fluorinated phthalocyanines with non-metal cores, e.g., silicon. Similarly, the disclosed microwave-assisted synthesis of macrocyclic complexes of formula PcM, wherein “Pc” is any phthalocyanine macrocycle and “M” is hydrogen, may be beneficially employed. Thus, the present disclosure extends to the synthesis of a wide range of fluorinated phthalocyanine molecules using various starting materials, as will be readily apparent to persons skilled in the art.

Although the present disclosure has been described with reference to exemplary and advantageous embodiments/implementations thereof, the present disclosure is not limited by or to such exemplary and advantageous embodiments/implementations.

1. A compound having the formula:
F₆₄PcM
wherein “F₆₄” stands for eight perfluoroisopropyl groups and eight aromatic fluorine groups, “Pc” is any phthalocyanine macrocycle, and “M” is V═O.

2. The compound according to claim 1, wherein synthesis involves reacting perfluoro-(4,5-di-isopropyl)phthalonitrile, VOCl3 and dimethyl formamide.

3. The compound according to claim 2, wherein the synthesis was microwave-assisted.

4. The compound according to claim 2, wherein purification is undertaken subsequent to synthesis.

5. The compound according to claim 4, wherein the purification comprises at least one washing step, sublimation and column chromatography.

6. The compound according to claim 2, wherein the yield is at least approximately 56%.

7. A compound having the formula:
F₆₄PcM
wherein “F₆₄” stands for eight perfluoroisopropyl groups and eight aromatic fluorine groups, “Pc” is any phthalocyanine macrocycle, and “M” is Cu.

8. The compound according to claim 7, wherein synthesis involves reacting perfluoro-(4,5-di-isopropyl)phthalonitrile and Cu(CH3COOH)2.H2O.

9. The compound according to claim 8, wherein the synthesis was microwave-assisted.

10. The compound according to claim 8, wherein purification is undertaken subsequent to synthesis.

11. The compound according to claim 10, wherein the purification comprises at least one washing step.

12. The compound according to claim 8, wherein the yield is at least approximately 45%.

13. A method for synthesizing perfluorophthalocyanine molecules, comprising:
providing a reaction mixture that includes a perfluoro compound and an acid catalyst; and
reacting the reaction mixture for a reaction period sufficient to yield a fluorinated phthalocyanine of formula: F₆₄PcM, wherein “Pc” is any phthalocyanine macrocycle and “M” is hydrogen.

14. The method according to claim 13, wherein the fluorinated phthalocyanine is 29H,31H-1,4,8,11,15,18,22,25-octa-fluoro-2,3,9,10,16,17,23,24-octa-perfluoroisopropylphthalocyanine.

15. The method according to claim 13, wherein the perfluoro compound in the reaction mixture includes a fluorinated phthalocyanine having a formula: F₆₄PcM′, wherein Pc is any phthalocyanine macrocycle and M′ is a metal or non-metal other than hydrogen.

16. The method according to claim 13, wherein the perfluoro compound in the reaction mixture derives from a perfluoro-phthalonitrile.

17. The method according to claim 16, wherein the perfluoro-phthalonitrile is reacted with PbO and dimethylformamide to form the perfluoro compound in the reaction mixture.

18. The method according to claim 13, wherein the acid catalyst is sulfuric acid.

19. The method according to claim 13, further comprising applying microwave energy to the reaction mixture during at least part of the reaction step.

20. The method according to claim 19, further comprising a purification step.
